(19) United States
(12) Patent Application Publication
(10) Pub. No.: US 2006/0058903 A1
(43) Pub. Date: Mar. 16, 2006

(54) Product, package and material code system and method for manufactured products

(75) Inventors: Hsun-Lan Chang, Hsin-Chu (TW); Shu-Chun Yuan, Hsin-Chu (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 10/928,787

(22) Filed: Aug. 27, 2004

(51) Int. Cl. G06F 19/00

(52) U.S. Cl. 700/100; 700/115; 700/97; 700/107

(57) ABSTRACT

A system for fabricating a product and a method for fabricating a product employ a data structure having a product table as a central element. The product table also has linked therewith a location table, a package table and a material table, such that the data structure may assist with efficient and reliable fabrication of the product. The invention optionally provides a package map table mapping the package table with the location table.

### BACKGROUND OF THE INVENTION

1. Field of the Invention

The invention relates generally to systems and methods for manufacturing products. More particularly, the invention relates to systems and methods for efficiently and reliably manufacturing products.

2. Description of the Related Art

Common in the microelectronic product fabrication art is the overlapping scheduling of production of a plurality of microelectronic product types within a plurality of microelectronic fabrication facilities (i.e., individual product types are fabricated in multiple facilities and individual facilities have fabricated therein multiple product types). Such distribution of production for multiple microelectronic product types within multiple microelectronic fabrication facilities is generally desirable within the microelectronic product fabrication art insofar as such distributed production generally provides for efficient workload balancing within microelectronic fabrication facilities.

Also common in the microelectronic product fabrication art is the use of multiple sub-contract manufacturers for fabricating product components and product sub-components under product performance specification and control of a prime manufacturer. The use of multiple sub-contract manufacturers within microelectronic product fabrication is also desirable for workload balancing considerations, as well as for cost control considerations.

While the use of sub-contract manufacturers for purposes of fabricating product components and product sub-components is desirable in the microelectronic product fabrication art, it is nonetheless not entirely without problems.

In that regard, it is often difficult within the microelectronic product fabrication art to efficiently and reliably control microelectronic product sub-contract manufacturers such as to provide microelectronic products, product components and product sub-components with enhanced quality and enhanced reliability.

It is towards the foregoing object that the present invention is directed.

Various systems and methods having desirable properties have been disclosed within arts including but not limited to microelectronic product fabrication arts for fabricating products such as but not limited to microelectronic products.

Included but not limiting among the systems and methods are those disclosed within: (1) Smirnov et al., in U.S. Pat. No. 6,347,256 (a process modeling system and method which provides for efficient manufacturing facility operation); (2) Hsu et al., in U.S. Pat. No. 6,347,258 (a data structure and a method for use thereof when fabricating microelectronic products); and (3) Nair et al., in U.S. Pat. No. 6,366,824 (a data coordination system and method applicable to a plurality of microelectronic fabrication facilities).

The disclosure of each of the foregoing references is incorporated herein fully by reference.

Desirable in the microelectronic product fabrication art are additional systems and methods for efficiently and reliably fabricating microelectronic products.

It is towards the foregoing object that the present invention is directed.

### SUMMARY OF THE INVENTION

A first object of the invention is to provide a system and a method for fabricating a microelectronic product.

A second object of the invention is to provide a system and a method in accord with the first object of the invention, wherein the microelectronic product is efficiently and reliably fabricated.

In accord with the objects of the invention, the invention provides a system for fabricating a microelectronic product and a method for fabricating the microelectronic product, as well as a data structure which may be employed within the system and the method for fabricating the microelectronic product.

Within the invention, the data structure comprises a product table comprising a plurality of product records, where each product record comprises: (1) a product code defining a product; (2) a location code for determining a location where the product is fabricated; (3) a package code for determining a package configuration of the product; and (4) a material code for determining a bill of materials for the product. Within the invention, the product table has linked therewith: (1) a location table comprising a plurality of location codes including the location code which defines the location where the product is fabricated; (2) a package table comprising a plurality of package codes including the package code which defines the package configuration of the product; and (3) a material table comprising a plurality of material codes including the material code for determining the bill of materials for the product.

Further in accord with the invention, a system in accord with the invention and a method in accord with the invention provide for an automatic qualification of a product incident to a new or revised material code for the product.

The invention provides a system and a method for fabricating a microelectronic product, wherein the microelectronic product is efficiently and reliably fabricated.

The invention realizes the foregoing object within the context of a data structure which may be employed within the context of the system and the method of the invention. The data structure comprises a product table as a core data repository, where the product table has linked thereto a location table, a package table and a materials table. By employing a data structure of the foregoing structural relationship, a product, such as in particular a microelectronic product, may be efficiently and reliably fabricated.

### DESCRIPTION OF THE PREFERRED EMBODIMENT

The objects, features and advantages of the invention are understood within the context of the Description of the Preferred Embodiment, as set forth below. The Description of the Preferred Embodiment is understood within the context of the accompanying drawings, which form a material part of this disclosure, wherein:

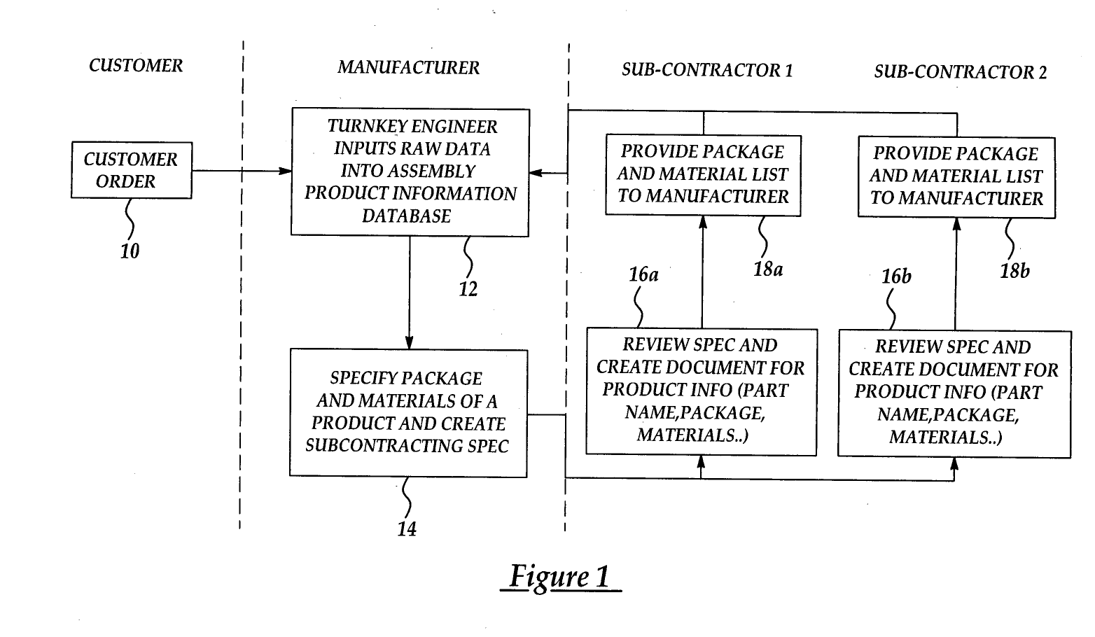

FIG. 1 shows a schematic process flow diagram for a sub-contracted manufacturing business process not in accord with the invention.

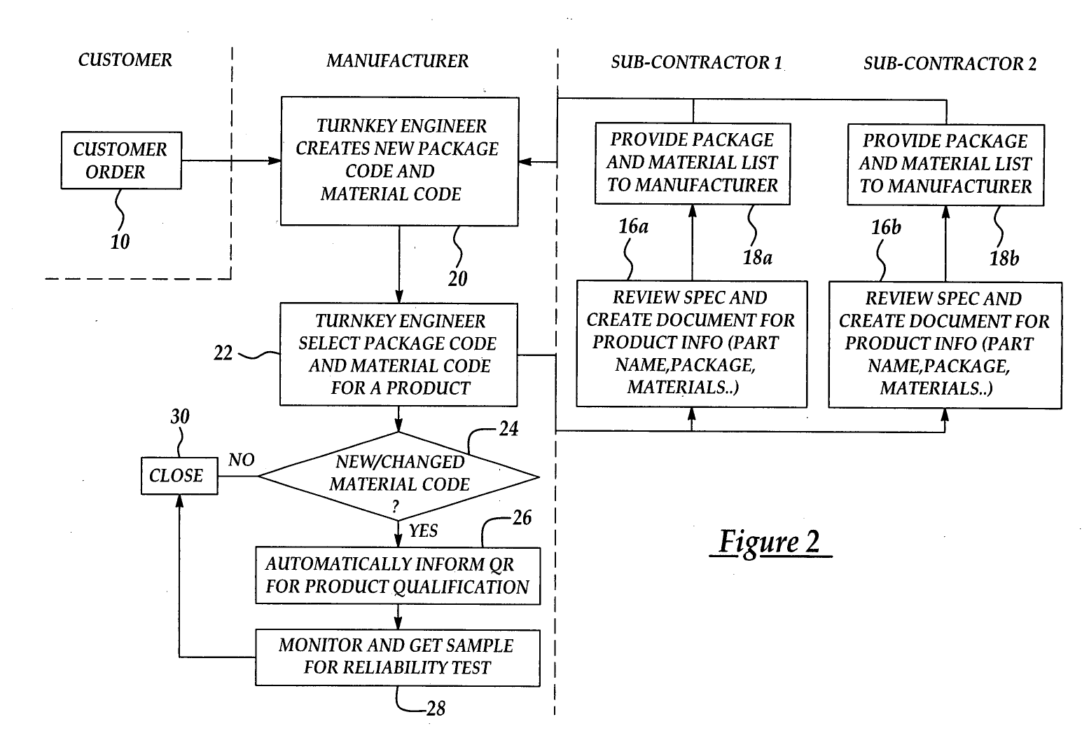

FIG. 2 shows a schematic process flow diagram for a sub-contracted manufacturing business process in accord with the invention.

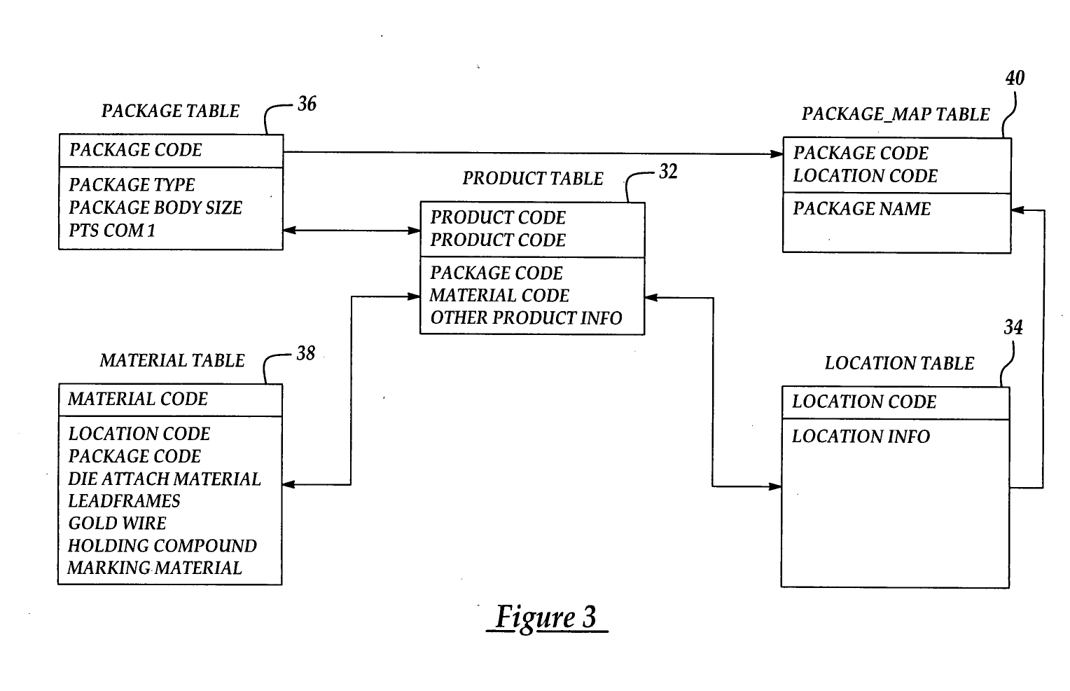

FIG. 3 shows a schematic diagram of a data structure in accord with the invention.

### DESCRIPTION OF THE PREFERRED EMBODIMENT

The invention provides a system and a method for fabricating a microelectronic product, wherein the microelectronic product is efficiently and reliably fabricated.

The invention realizes the foregoing object within the context of a data structure which may be employed within the context of the system and the method of the invention. The data structure comprises a product table as a core data repository, where the product table has linked thereto a location table, a package table and a materials table. By employing a data structure of the foregoing structural relationship, a product, such as in particular a microelectronic product, may be efficiently and reliably manufactured.

While the preferred embodiment of the invention illustrates the invention more particularly within the context of efficiently and reliably fabricating a microelectronic product, such as a semiconductor packaging product, the present invention is not intended to be so limited. Rather the invention may be employed in efficiently and reliably fabricating products including but not limited to electrical, mechanical and chemical products. With respect to microelectronic products, the invention may be employed for efficiently and reliably fabricating microelectronic products including but not limited semiconductor products, semiconductor and other microelectronic packaging products and optoelectronic products.

In addition, while the present invention provides particular value within the context of control of a multiple sub-contractor scheme for fabricating a microelectronic product, the invention may also be employed within the context of monitoring and control of multiple captive fabrication facilities for fabricating multiple microelectronic products.

Finally, although not specifically illustrated within the context of the drawings which comprise a portion of this disclosure, the invention is intended as a computer assisted invention which employs a computer, associated databases and user interface means (such as customer product ordering means) in accord with systems and methods as are disclosed within the related art references cited within the Description of the Related Art. Again, the disclosures of those related art references are incorporated herein fully by reference.

FIG. 1 shows a schematic diagram of a sub-contracted microelectronic product manufacturing business process not in accord with the invention. The business process as illustrated within FIG. 1 provides a basis for understanding the nature and scope of the invention.

As is illustrated within FIG. 1, and in accord with reference numeral 10, a customer places a customer order with a manufacturer for a product, such as a microelectronic product. As is also illustrated within FIG. 1, and in accord with reference numeral 12, a turnkey engineer associated with the manufacturer determines raw material requirements for fabrication of the product and inputs that data into an appropriate product assembly database. In accord with reference numeral 14, the manufacturer specifies packaging constraints and fabrication materials for fabricating the product, and creates a sub-contracting specification. In turn, and in accord with reference numerals 16a and 16b, a plurality of sub-contractors reviews the sub-contracting specification and creates their own internal documentation with respect to product number, product packaging and product fabrication materials. Finally, and in accord with reference numerals 18a and 18b, the plurality of sub-contractors provides their product packaging and product fabrication materials lists to the manufacturer for further review.

While the sub-contracted manufacturing business process as illustrated in FIG. 1 may be a generally common business process, it is nonetheless not entirely without problems. In that regard: (1) the business process in general does not necessarily preclude the use of improper or unauthorized materials when a customer ordered product is fabricated by a sub-contractor; (2) the review process does not provide for a quality assurance and reliability review of a customer ordered product when the same is produced with a new or changed material; and (3) the review process acknowledges that product naming conventions employed by a manufacturer may not correspond with product naming conventions employed by a sub-contractor, thus potentially providing for difficulty in customer ordered product tracking within a sub-contractor fabrication facility.

The present invention is intended to address, at least in part, the foregoing deficiencies with respect to the sub-contracted manufacturing business process as is illustrated within FIG. 1. To achieve that result, the invention employs a sub-contracted manufacturing business process as illustrated in FIG. 2.

The business process as illustrated in FIG. 2 corresponds generally with the business process as illustrated in FIG. 1, but employs a different set of business process steps with respect to a manufacturer.

In that regard, and instead of inputting new product raw data into an assembly product information database and generating a subcontracting specification for a new product in accord with reference numerals 12 and 14 as illustrated in FIG. 1, in accord with reference numeral 20 a manufacturer representative, such as a turnkey engineer, creates a new package code and a new material code for a new product when ordered by a customer. In the alternative and for an existing product, in accord with reference numeral 22 the turnkey engineer selects an existing package code and material code for a product. Within the invention, a content and interrelationship between package codes and material codes is disclosed in greater detail below. Within the invention, a bill of materials within a material code may be revised independently of a package code (and also a product code as further discussed below).

The business process as illustrated in FIG. 2 also additionally provides in accord with reference numerals 24, 26, 28 and 30 an automatic determination of whether a material code is new or changed with respect to a customer product order (i.e., whether any materials with a bill of materials associated with a material code is new or has changed). If so, the business process of the invention provides for an automatic implementation of a reliability qualification for the product.

Significant to the present invention is a data structure employed within the context of the sub-contracted manufacturing business process as illustrated in FIG. 2.

The data structure as employed within the invention is illustrated within the schematic diagram of FIG. 3.

FIG. 3 illustrates a product table 32 as a central component of the data structure. The product table 32 in turn has contained therein a series of product records, each corresponding with a product that is fabricated within at least one sub-contractor facility and preferably a plurality of sub-contractor facilities. In turn, each of the product records comprises: (1) a product code which is an arbitrarily assigned code which corresponds with a particular product desired to be fabricated at a sub-contractor facility; (2) a location code which is employed for determining the location of a sub-contractor which may fabricate the product; (3) a package code employed in defining packaging characteristics of the product; (4) a material code employed in defining a bill of materials for the product at a particular sub-contractor; and (5) other individual product information which is not otherwise specifically enumerated.

Also illustrated within the schematic diagram of FIG. 3, and linked with the product table 32, is a location table 34, a package table 36 and a material table 38.

Within the invention, the location table 34 contains a series of location code records in turn containing location information of sub-contractor facilities where a product may be fabricated. In addition, the package table 36 contains a series of package code records, each having associated therewith packaging information for the product. Within the preferred embodiment of the invention when the product is a semiconductor packaging product, the packaging information will typically include information such as but not limited to package type, package body size and package pin count, as illustrated in accord with reference numeral 36. Finally, the material table 38 has contained therein a series of material code records, each material code record having a corresponding location code and package code, along with a bill of materials for fabricating a specific package of a specific product at a specific location. Within the preferred embodiment of the invention when the product is a semiconductor packaging product, the bill of materials may include, but is not limited to, materials such as but not limited to die attach materials, leadframe materials, gold wire materials, molding compound materials and marking materials, as illustrated in accord with reference numeral 38 within FIG. 3.

By employing within the invention the package code and the corresponding package table 36, as well as the material code and the corresponding material table 38, enhanced efficiency is provided in sub-contracted manufacturing of a product insofar as packaging and material information is contained within an organized database rather than within sub-contracting specifications.

Finally, FIG. 3 also illustrates a package map table 40 which is intended to map package codes within the package table 36 with location codes within a location table 34 such as to provide for ready access of product tracking information under circumstances where a manufacturer and a sub-contractor do not necessarily employ the same code when designating a product. The package map table 40 thus provides for enhanced tracking of a customer ordered product within a fabrication facility under such circumstances.

As is understood by a person skilled in the art, the preferred embodiment of the invention is illustrative of the invention rather than limiting of the invention. Revisions and modifications may be made to methods, materials, structures and dimensions in accord with the preferred embodiment of the invention while still providing an embodiment of the invention, further in accord with the accompanying claims.

What is claimed is:

1. A data structure comprising:
a product table comprising a plurality of product records, each product record comprising:
a product code defining a product;
a location code for determining a location where the product is fabricated;
a package code for determining a package configuration of the product; and
a material code for determining a bill of materials for the product, where the product table has linked therewith:
a location table comprising a plurality of location code records including the location code record which defines the location where the product is fabricated;
a package table comprising a plurality of package code records including the package code record which defines the package configuration of the product; and
a material table comprising a plurality of material code records including the material code record for determining the bill of materials for the product.

2. The data structure of claim 1 further comprising a package map table, where the package map table correlates the package table and the location table.

3. The data structure of claim 1 wherein each of the plurality of material code records is cross referenced with a package code record and a location code record.

4. The data structure of claim 1 wherein the product is selected from the group consisting of electrical products, mechanical products and chemical products.

5. The data structure of claim 1 wherein the product is a microelectronic product.

6. The data structure of claim 1 wherein the product is a semiconductor packaging product.

7. A system for fabricating a product comprising:
a computer having a database and a means for accessing the database;
a product table contained within the database, the product table comprising a plurality of product records, each product record comprising:
a product code defining a product;
a location code for determining a location where the product is fabricated;
a package code for determining a package configuration of the product; and
a material code for determining a bill of materials for the product, where the product table has linked therewith and also contained within the database:
a location table comprising a plurality of location code records including the location code record which defines the location where the product is fabricated;
a package table comprising a plurality of package code records including the package code record which defines the package configuration of the product; and
a material table comprising a plurality of material code records including the material code for determining the bill of materials for the product.

8. The system of claim 7 further comprising a package map table, where the package map table correlates the package table and the location table.

9. The system of claim 7 further comprising a product order entry function.

10. The system of claim 9 further comprising a notification function such that a product when ordered with a new or changed material code receives a reliability quality inspection.

11. The system of claim 7 wherein each of the plurality of material code records is cross referenced with a package code record and location code record.

12. The system of claim 7 wherein the product is selected from the group consisting of electrical products, mechanical products and chemical products.

13. The system of claim 7 wherein the product is a microelectronic product.

14. The system of claim 7 wherein the product is a microelectronic packaging product.

15. The system of claim 7 wherein the location where the product is fabricated is a sub-contractor location.

16. A method for fabricating a product comprising:
defining for a product a product code;
determining for the product a series of packaging requirements and defining the same within a package code;
determining for the product a bill of materials defining the same within a material code, where the bill of materials may be revised independent of the product code or the package code;
correlating the product code with the package code and the material code;
ordering the product; and
automatically requiring a product qualification if the bill of materials for the product is new or has been revised since the product was last ordered.

17. The method of claim 16 wherein each of the product code, the package code and the material code defines product information, package information and material information resident as records within a corresponding product table database, package table database and material table database.

18. The method of claim 16 wherein the product is selected from the group consisting of electrical products, mechanical products and chemical products.

19. The method of claim 16 wherein the product is a microelectronic product.

20. The method of claim 16 wherein the product is a microelectronic packaging product.
